(19) United States
(12) Patent Application Publication
(10) Pub. No.: US 2011/0090831 A1
(43) Pub. Date: Apr. 21, 2011

(54) POWER CONSERVATION FOR A WIRELESS DEVICE

(76) Inventor: JOHN S. HOWARD, Portland, OR (US)

(21) Appl. No.: 12/959,434

(22) Filed: Dec. 3, 2010

Related U.S. Application Data
(63) Continuation of application No. 10/946,779, filed on Sep. 22, 2004.

(51) Int. Cl. H04W 52/02

(52) U.S. Cl. 370/311

(57) ABSTRACT

A technique includes in response to a message identifying whether a second wireless device is one of a first set of wireless devices targeted for communication during a time interval, selectively reducing power in the second wireless device during the time interval.

This application is a continuation of U.S. patent application Ser. No. 10/496,779 filed Sep. 22, 2004 entitled “Power Conservation for a Wireless Device,” the content of which is hereby incorporated by reference.

### BACKGROUND

The invention generally relates to power conservation for a wireless device.

A typical computer system may include a wireless network to establish communication between a wireless-capable host computer (the “host”) and wireless end points (a wireless camera, a wireless keyboard, a wireless personal digital assistant (PDA), as just a few examples). The wireless end points may be battery-powered, which means that it may be desirable to conserve the power that is consumed by these devices for purposes of extending battery life.

The host may communicate with the wireless end points using a time division multiplexing scheme, a communication protocol in which communication between the host and a particular wireless end point occurs during one or more assigned time slots. Before communicating with a particular wireless end point, the host transmits a broadcast message that identifies the wireless end point as the target of the upcoming communication and reserves time slots (to the exclusion of the other wireless end points) for this communication. Thus, each communication between the host and a wireless end point is preceded by a broadcast message.

For purposes of conserving power, each wireless end point may monitor all broadcast commands that are transmitted from the host computer. By monitoring each broadcast command, each wireless end point may be able to determine whether or not the wireless end point should remain powered on for the time slot(s) that are allocated for the associated broadcast message. If the wireless end point determines that the broadcast message targets the end point, then the end point remains powered on to communicate with the host. Otherwise, if the broadcast message does not target the wireless end point, then the wireless end point may power down for the time slot(s) that are associated with the broadcast message and then power up again to monitor the next broadcast message. However, a particular wireless end point may consume a considerable amount of power monitoring broadcast messages that do not target the wireless end point.

Thus, there is a continuing need for better ways to conserve power in a wireless device.

### BRIEF DESCRIPTION OF THE DRAWING

FIG. 1 is a schematic diagram of a wireless environment according to an embodiment of the invention.

FIG. 2 is an illustration of a time allocation for wireless communications in the wireless environment according to an embodiment of the invention.

FIG. 3 is an illustration of a time allocation for a superframe according to an embodiment of the invention.

FIG. 4 is an illustration of a time allocation for a macro time slot according to an embodiment of the invention.

FIGS. 5, 6 and 7 are flow diagrams depicting techniques to conserve power in a wireless device according to different embodiments of the invention.

FIG. 8 is a state diagram of a wireless device according to an embodiment of the invention.

FIG. 9 is a schematic diagram of a wireless device according to an embodiment of the invention.

### DETAILED DESCRIPTION

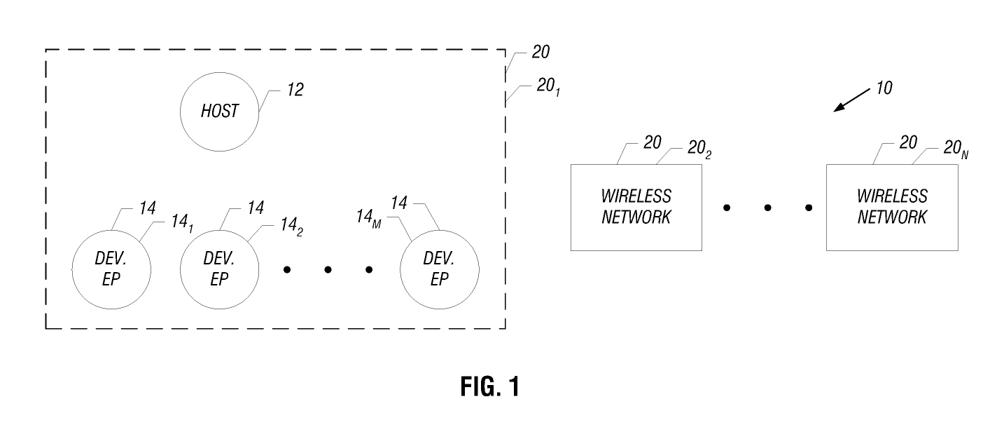

Referring to FIG. 1, a wireless environment 10 in accordance with an embodiment of the invention includes wireless networks 20 (wireless network 20₁, 20₂ . . . 20_{N}, depicted as examples) that generally use the same frequency communication channels. Therefore, to avoid potential interference between the networks 20, the wireless networks 20 use a time division multiplexing scheme that allocates different time slots for the wireless networks 20. During a time slot assigned to a particular wireless network 20 (to the exclusion of the other wireless networks 20), components of the network 20 may communicate wirelessly with each other without experiencing interference from nearby networks 20.

More specifically, in some embodiments of the invention, the wireless networks 20 are assigned different time slots (called “macro time slots” herein) for internal network communication. The assignment of macro time slots extends over a larger interval of time called a superframe. Each wireless network 20 may be assigned several, one or even no macro time slots during a particular superframe. The superframe has a fixed duration, in that each superframe includes a defined number of macro time slots that are successive in time within the superframe. The superframes are also consecutive in time, so that when one superframe ends, another superframe that may contain different macro time slot assignments begins. The assignment of macro time slots may be assigned on a first-come basis, on a priority basis, etc.

As depicted in FIG. 1, a particular wireless network 20₁ may include a wireless host computer (herein called the “host 12”) that communicates with wireless devices (called “wireless end points 14” herein), such as wireless end points 14₁, 14₂ . . . 14_{M}, depicted as examples. In the example shown in FIG. 1, the wireless network 20₁ has M wireless end points 14. It is noted that in the various embodiments of the invention, each of the other wireless networks 20 may have M wireless end points 14, or fewer or more than M wireless end points 14.

In some embodiments of the invention, the host 12 may communicate with the wireless end points 14 using a Universal Serial Bus (USB)-type standard. For example, in some embodiments of the invention, the host and wireless end points 14 may communicate using a wireless Universal Serial Bus (WUSB) protocol based on ultrawideband technology. Pursuant to this protocol, the host 12 initiates all communication (via a broadcast message) with the wireless end points 14 and reserves data bandwidth (for wireless communication) for each wireless end point 14. Thus, the network 20 may be a “hub and spoke” network, in some embodiments of the invention, with the host 12 being the “hub,” and the “spokes” extending to the wireless end points 14. The “spokes” may be the only allowed data communication (between the wireless endpoints 14 and the host 12), as any two wireless endpoints 14 may not be permitted to communicate directly between themselves. The WUSB protocol may generally follow the protocol that is set forth in the wired Universal Serial Bus Specification Revision 2.0 that was released on Apr. 27, 2000, and is available on the worldwide web at usb.org.

As described further below, in some embodiments of the invention, each wireless end point 14 uses a power conservation technique so that the end point 14 only fully powers up when an upcoming (the next time slot, for example) time slot is designated for communication between the host 12 and the wireless end point 14. As described further below, in some embodiments of the invention, the wireless end point 14 learns the upcoming time slots that are assigned to the wireless end point 14 based on communications from the host 12.

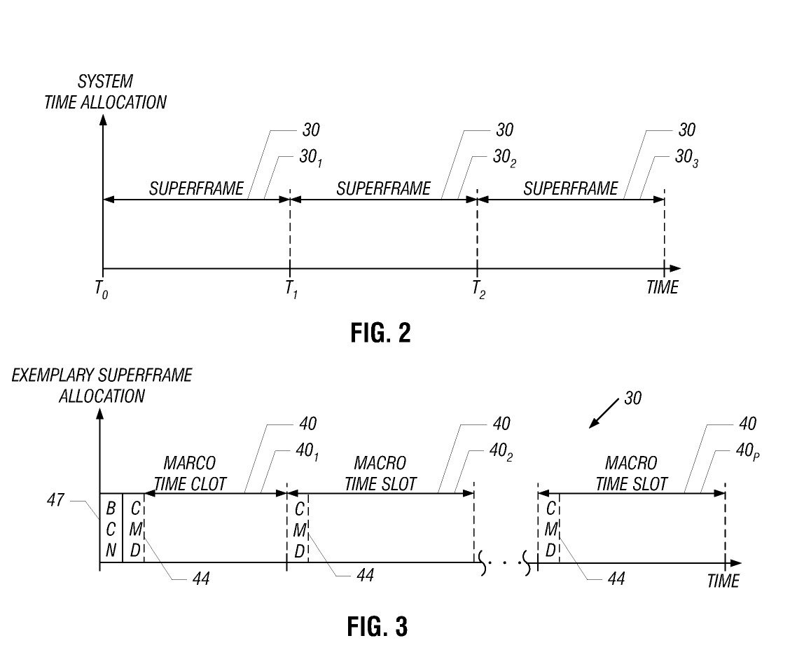

Referring to FIG. 2, in some embodiments of the invention, the time for wireless communications in the environment 10 (FIG. 1) may be allocated in superframes 30 (superframes 30₁, 30₂ and 30₃, depicted as examples). As shown, the superframes 30 occur successively in time. Each superframe 30 includes macro time slots (occurring successively in time with the superframe 30), each of which may be assigned exclusively to a particular wireless network 20 (FIG. 1) so that components of the network 20 may communicate in the macro time slot.

As a more specific example, FIG. 3 depicts an exemplary superframe 30. As shown, the superframe 30 includes P macro time slots 40 (macro time slots 40₁, 40₂. . . 40_{P}, depicted as examples) that are successive in time and, each of which may be assigned to a particular wireless network 20. Thus, for example, macro time slots 40₁ and 40₂ may be assigned to the wireless network 20₁ (see FIG. 1) and the macro time slot 40_{P} may be assigned to the wireless network 20₂ (see FIG. 1).

In accordance with some embodiments of the invention, each macro time slot 40 is associated with a command packet 44, a message that is broadcast by the host 12 (FIG. 1) to all wireless end points 14 (FIG. 1). As depicted in FIG. 3, in some embodiments of the invention, the host 12 may transmit the command packet 44 at the beginning of an associated macro time slot 40. However, other arrangements are possible in other embodiments of the invention. For example, in some embodiments of the invention, the command packet 44 may be located near the end of a particular macro time slot 40 and contain information about (and thus, be associated with) the next macro time slot.

Regardless of the particular timing of the command packet 44 relative to the associated macro time slots 40, the command packet 44 is broadcast by the host 12 and identifies which wireless end points 14 will be communicating during the associated macro time slot 40. In some embodiments of the invention, each macro time slot 40 is subdivided into time slot(s) (herein called “micro time slot(s)”), each of which a slice of time that may be exclusively reserved for communication between the host 12 and one of wireless end points 14.

In some embodiments of the invention, the micro time slot assignments may be determined by the host 12 prior to the beginning of the macro time slot 40. For this type of static assignment of the micro time slots by the host 12, the host 12 may communicate the micro time slot assignments via the command packet 44. Thus, in some embodiments of the invention, the command packet 44 may identify which wireless end points will be communicating during the associated macro time slot 40 and the micro time slot assignments for the macro time slot 40.

However, in other embodiments of the invention, the host 12 may dynamically assign the micro time slots during a particular macro time slot 40, as the macro time slot 40 progresses. Thus, during the course of a particular macro time slot 40, the host 12 may dynamically assign upcoming micro time slots (to the wireless end points 14 identified in the command packet 44) based on a first-come-first serve basis, bandwidths, retries needed, etc. The same time allocation criteria may also be used by the host 12 for embodiments of the invention in which the host 12 determines the micro time slot assignments prior to the beginning of the macro time slot 40.

Referring to FIG. 3, in conjunction with FIG. 1, as an example of the static micro time slot assignment embodiments of the invention, a particular command packet 44 may identify that in the associated macro time slot 40, the host 12 reserves time for communication with the wireless device end point 14₂. Furthermore, the command packet 44 may indicate that micro time slots 2, 5 and 10 are reserved for communication between the host 12 and the device end point 14₂ during this macro time slot 40. Thus, in view of this information, in some embodiments of the invention, the wireless device end point 14₂ in this macro time slot 40 powers down, or enters a power conservation state, in micro time slots other than micro time slots 2, 5 and 10 and powers up in micro time slots 2, 5 and 10. Thus, power is conserved in the device end point 14₂, as the device end point 14₂ powers down (to some extent) when not communicating with the host 12. As a result of the inclusion command of the packet 44, the wireless end point 14₂ does not need to monitor all broadcast messages that are transmitted by the host 12 during the macro time slot 40. Rather, the wireless end point 14₂ “ignores” (by powering down) any messages that are transmitted by the host 12 during micro time slots other than micro time slots 2, 5 and 10 to minimize the power consumption of the device 14₂.

For the dynamic micro time slot assignment embodiments of the invention, the host 12 broadcasts messages (in addition to the packet 44) during the macro time slot identifying upcoming micro time slot assignments. The wireless end points 14 that are not identified in the packet 44 remain powered down for the duration of the macro time slot 40 associated with the packet 44.

In the context of this application, “powering down” generally refers to a significant reduction in the overall power that is consumed by the wireless end point 14, such as a complete powering off of the end point 14 or the powering off a particular section of the end point 14 such as the end point's receiver or transceiver, for example.

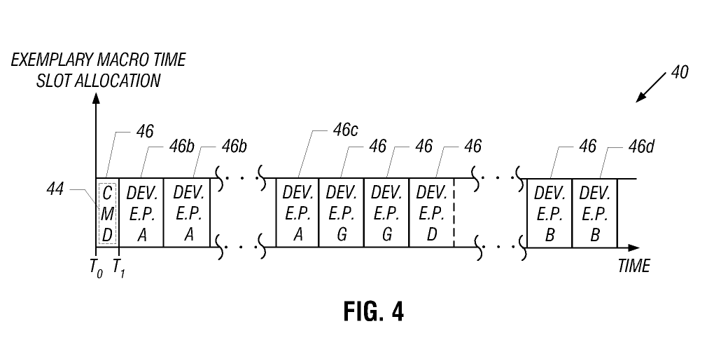

Referring to FIG. 4, as a more specific example of embodiments of the invention in which the host 12 determines the micro time slot assignments before the beginning of the macro time slot 40, a particular macro time slot 40 may include a command packet 44 that identifies, micro time slots 46, such as, for example, micro time slots 46b and 46c as being dedicated for communication between the host 12 and the device end point A, identifies micro time slot 46_{d} as being dedicated for communication between the host 12 and a device end point B, etc. For embodiments of the invention in which the host 12 dynamically assigns the micro time slots during the macro time slot, the packet 44 is less complex in nature, in that the packet 44 only identifies which wireless devices are going to be accessed during the associated macro time slot 40.

Referring back to FIG. 3, in some embodiments of the invention, not only does the host 12 broadcast the command packets 44 that identify the micro time allocation for a particular macro time slot, the host 12 may also broadcast a beacon 47, another message, at the beginning of each superframe 30. The beacon 47 identifies which wireless device end points 14 are active during an upcoming superframe 30. Thus, the use of the beacon 47 provides advance notice to the wireless end points 14 as to which end points 14 will be communicating during the superframe 30 that is associated with the beacon 47. Furthermore, depending on the particular embodiment of the invention, in a particular beacon 47, the host 12 may indicate that a particular wireless end point 14 is not going to be communicating for a predetermined number of superframes 30. Therefore, the use of the beacon 47 permits the wireless end points 14 to power down for one or possibly successive superframes 30 to conserve power during the superframe(s) 30 in which the end points 14 do not communicate.

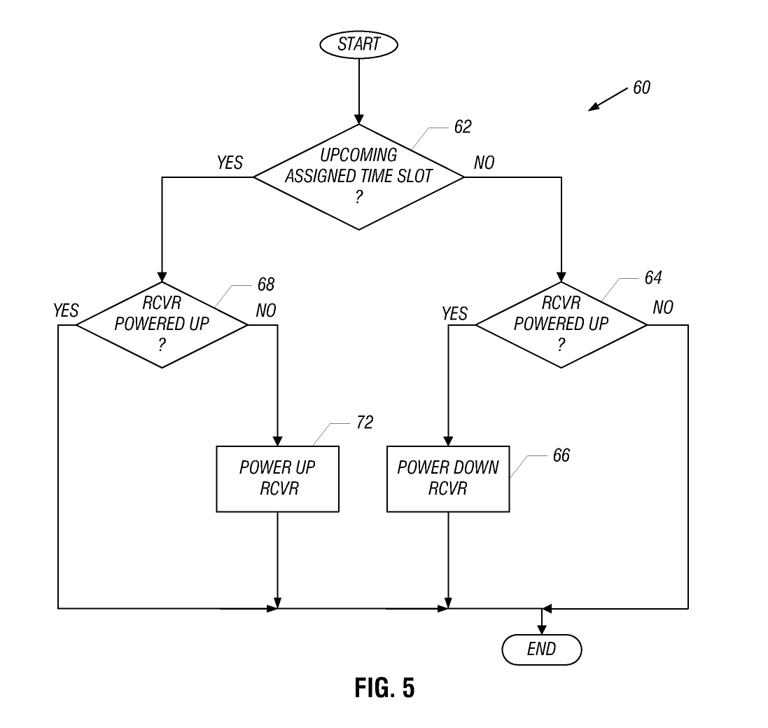

Referring to FIG. 5, thus, in some embodiments of the invention, a technique 60 may be used by a wireless end point 14 (FIG. 1) to conserve power. The technique 60 is an example of embodiments of the invention in which the host 12 statically assigns micro time slots before the beginning of the associated macro time slot 40. The technique 60 includes determining (diamond 62) whether an upcoming time slot is assigned for the wireless end point 14. If so, then the wireless end point 14 determines (diamond 68) whether a receiver of the end point 14 is powered up. If so, the technique 60 ends. Otherwise, the end device 14 powers up the receiver, as depicted in block 72.

If the wireless end point 14 determines (diamond 62) that the upcoming time slot is not assigned, then the end device 14 determines (diamond 64) whether its receiver is powered up. If not, the technique 60 ends. Otherwise, the wireless end point 14 powers down its receiver, as depicted in block 66.

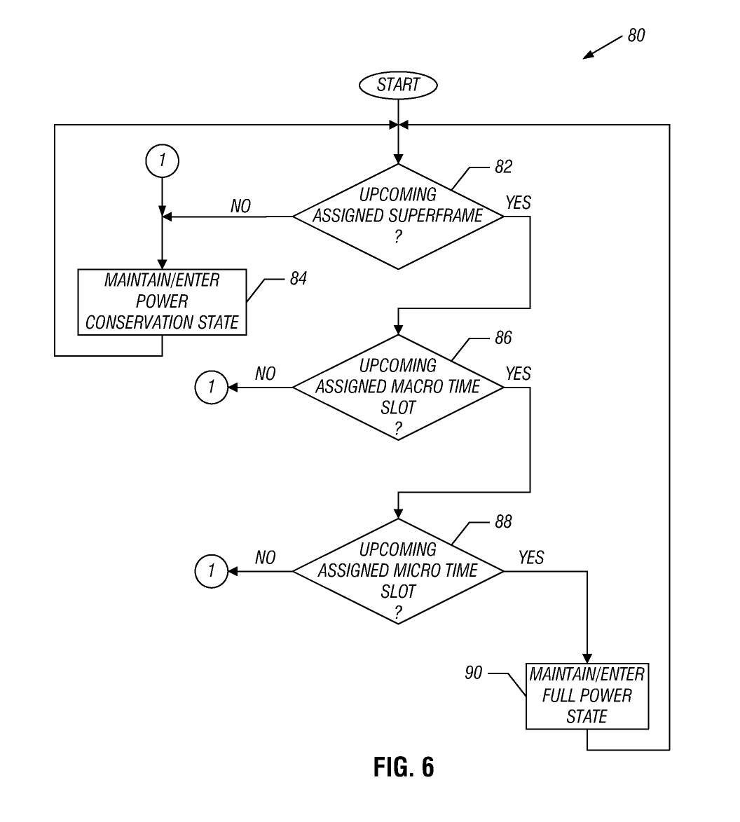

As a more specific example, in some embodiments of the invention, the wireless end point 14 may perform a technique 80 that is depicted in FIG. 6. Referring to FIG. 6, in accordance with the technique 80, the wireless end point 14 determines (diamond 82) whether the upcoming superframe (the next superframe, for example) has been assigned. If not, then the wireless end point 14 maintains or enters a power conservation state, as depicted in block 84. This power conservation state may be achieved through powering down the wireless end point's receiver, in some embodiments of the invention.

If, however, the wireless end point 14 determines (diamond 82) that the upcoming superframe is assigned to the wireless end point 14, then the end device 14 determines (diamond 86) whether the next upcoming macro time slot in the superframe has been assigned to the wireless end point 14. If not, then the wireless end point 14 proceeds as depicted in block 84. Otherwise, the wireless end point 14 determines (diamond 88) whether the next micro time slot in the current macro time slot has been assigned to the end device 14. If not, the wireless end point 14 proceeds as depicted in block 84. Otherwise, the wireless end point 14 maintains or enters a full power state, as depicted in block 90. In this manner, in the full power state, in some embodiments of the invention, the wireless end point 14 powers up its receiver.

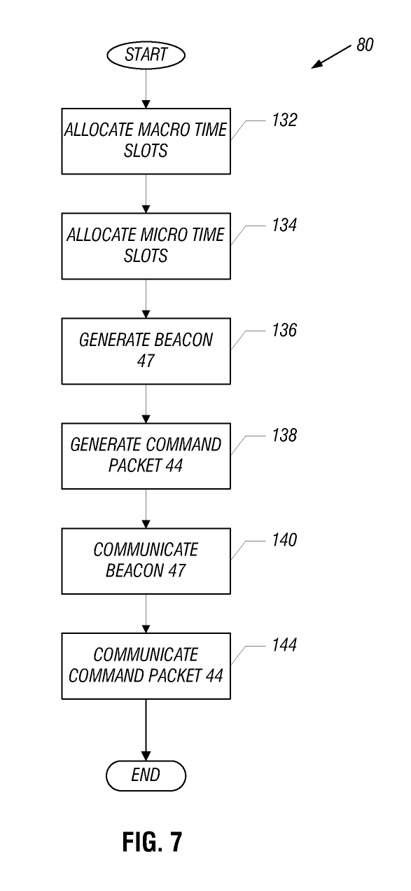

In accordance with some embodiments of the invention, the environment 10 (FIG. 1) may use a technique 130 that is depicted in FIG. 7. Referring to FIG. 7, pursuant to the technique 130, the wireless networks 20 allocate (block 132) macro time slots for a particular superframe. Next, the host 12 of each wireless network 20 allocates (block 134) micro time slots for each macro time slot. The host 12 of each wireless network 20 then generates (block 136) the beacon 47, a message, identifying superframe assignments and generates (block 138) the command packet 44, identifying micro time assignments. Subsequently, the host 12 communicates (block 140) the beacon 47 and communicates (block 144) the command packets 44.

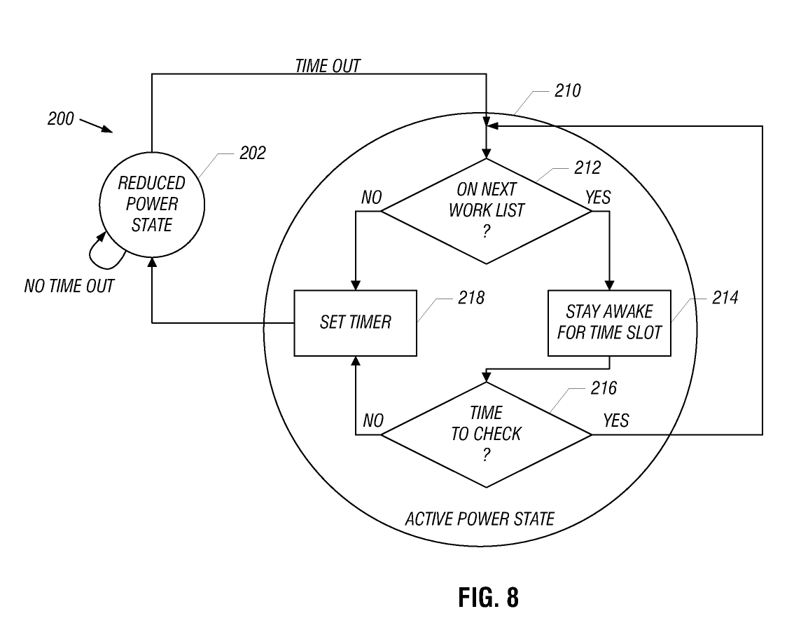

Other embodiments are within the scope of the appended claims. For example, in some embodiments of the invention, the host 12 (FIG. 1) may dynamically assign micro time slots, and each wireless end point 14 (FIG. 1) may be represented by a state diagram 200 that is depicted in FIG. 8. Referring to FIG. 8, the wireless end point 14 may generally have a reduced power state 202 in which the wireless end point 14 consumes less power and an active power state 210 in which the wireless end point 14 consumes relatively more power. In the active power state 210, the wireless end point 14 determines (diamond 212) whether the end point 14 is on the next work list. In other words, the wireless end point 14 determines whether the end point 14 (as indicated by the beacon 47 or command packet 44) has been identified as a target of communication during the next time slot (macro time slot 40 or superframe 30). If not, control transitions to block 218, further described below.

If the wireless end point 14 is the target of communication during the time slot, then the end point 14 stays awake for the time slot, as depicted in block 214, and determines (diamond 216) whether it is time to check the end point's status for the next time slot (macro time slot 40 or superframe 30). If so, control transitions to diamond 212. Otherwise, the wireless end point 14 sets (block 218) a timer by, for example, writing a value into the timer indicative of a duration of time.

The timer controls how long the wireless end device 14 remains in the reduced power state 202. Thus, if the wireless end device 14 determines from a particular beacon 37 that the end device 14 is not a communication target during the upcoming superframe 30, then the end device 14 programs the appropriate value into the timer so that the end device 14 remains in the reduced power state during this superframe. As another example, if the wireless end device 14 determines from a particular packet 44 that the end device 14 is not a communication target during the upcoming macro time slot 40, then the end device 14 programs the appropriate value into the timer so that the end device 14 remains in the reduced power state during this macro time slot.

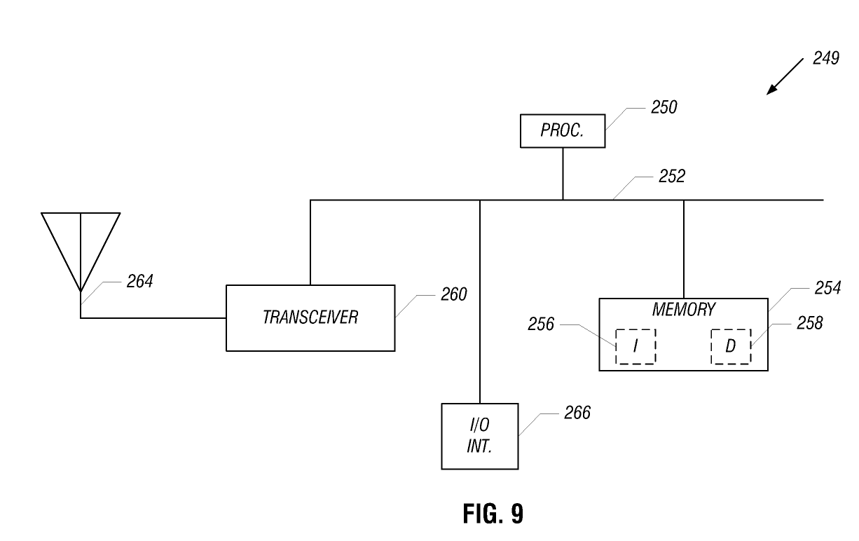

Referring to FIG. 9, in some embodiments of the invention, the host 12 and the wireless end point 14 may each have a general architecture 249 that is depicted in FIG. 8. The architecture 249 includes a processor 250 (one or more microcontrollers or microprocessors, depending on the particular embodiment of the invention) that is coupled to a system bus 252. Also coupled to the system bus 252 are a wireless interface 260 and a system memory 254. Furthermore, an input/output (I/O) interface 266 may be coupled to the system bus 252. The wireless interface includes, for example, a transceiver 260 (a receiver and a transmitter) and a wireless antenna 264 (a dipole antenna, for example) that is coupled to the transceiver 260 that may be used for purposes of communicating between the host 12 and the wireless end points 14.

The memory 254 may store instructions 256 as well as a data 258. For example, for the host 12, the memory 254 stores instructions 256 to cause the host 12 to generate and communicate the command packets 44 and beacons 47, as described above. The data 258 may include, for example, data describing the various end points 14, such as retries, bandwidths, accumulated data to the communicated to the end devices 14, etc. For the wireless end point 14, the memory 254 may include instructions 256 for purposes of performing the power conservation technique described herein, and the data 258 may include information from the command packets 44 and beacons 47, for example.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1-30. (canceled)

31. A method comprising:
with a wireless USB (WUSB) device, in response to a control packet indicating that the WUSB device is not targeted for communication during a time interval, reducing power in the WUSB device during the time interval.

32. The method of claim 31, further comprising: a second WUSB device to receive the message from a host that is to communicate with the second WUSB device within the time interval.

33. The method of claim 32, wherein the host exclusively controls a schedule of communications between the host and the second wireless devices within the time interval.

34. A method comprising:
transmitting a first message identifying first wireless devices targeted for communication within a first time interval, the first time interval comprising successive time slots; for each time slot, transmitting a second message identifying which of the first wireless devices are targeted during the time slot; in response to the first message, determining whether a second wireless device is one of the identified first wireless devices targeted for communication within the first time interval; and
selectively reducing power in the second wireless device in response to the determination.

35. The method of claim 34, further comprising: processing at least one of the second messages in response to determining whether one of the first devices in targeted for communication in the time interval.

36. The method of claim 34, further comprising: selectively powering down the second wireless device in response to the determination.

37. An apparatus, comprising:
a computing device having a wireless USB host to communicate with at least one device, the host to transmit a control packet to indicate to the device when it is to be active to enable it to reduce power when it is not to be active.

38. The apparatus of claim 37, wherein the host is to broadcast a beacon at the beginning of a superframe.

39. The apparatus of claim 37, wherein the beacon is to identify one or more wireless devices that are to be active during an upcoming superframe.

40. The apparatus of claim 34, in which the control packet indicates one or more slots within a superframe when the device is to be active.

41. An apparatus comprising:
a transmitter; and
a processor coupled to the transmitter to transmit a first message identifying wireless devices targeted for communication within a superframe, the superframe comprising time slots that are assigned among a plurality of wireless networks, and for each time slot, transmit a second message identifying communication timing for the wireless devices within the macro time slot.

42. The apparatus of claim 41, wherein the processor assigns the time slots to different wireless networks and assigns the communication timing inside each time slot to wireless devices of one of the wireless networks.

43. The apparatus of claim 41, wherein the transmitter transmits the first message near the beginning of the superframe
